(19) United States
(12) Patent Application Publication
(10) Pub. No.: US 2025/0012334 A1
(43) Pub. Date: Jan. 9, 2025

(54) CALIPER BRAKE

(71) Applicant: HL MANDO CORPORATION, Pyeongtaek-si (KR)

(72) Inventors: Hatem SHAHIN, Pfaffenhofen (DE); Florian WEICHERT, Wiesbaden (DE); Volker KINDER, Russelsheim (DE); Lothar WAGNER, Simmern (DE); Kai BRAUN, Friedrichsdorf (DE); Moritz RIEMER, Waldems (DE)

(73) Assignee: HL MANDO CORPORATION, Pyeongtaek-si (KR)

(21) Appl. No.: 18/423,997

(22) Filed: Jan. 26, 2024

(30) Foreign Application Priority Data
Jul. 7, 2023 (DE) 102023206498.7

(51) Int. Cl. F16D 65/097; F16D 65/00; F16D 65/12

(52) U.S. Cl. CPC F16D 65/0972; F16D 65/0068; F16D 65/127

(57) ABSTRACT

Disclosed herein is a caliper brake. The caliper brake according to one embodiment of the present disclosure includes: a disc rotating together with a wheel of a vehicle; a housing including a finger formed to be bent on one side, a cylinder formed to oppose the finger on the other side, and a bridge provided between the finger and the cylinder, and provided to cover at least a part of the disc; a piston provided in the cylinder to move forward and backward to and from the finger; and a pad assembly provided in each of the finger and the cylinder to press or release both sides of the disc by moving forward and backward by the piston, and at least one of the housing, the piston, or the pad assembly is provided with a first material including wood or by combining the first material and a second material that is metal.

### CROSS-REFERENCE TO RELATED APPLICATION

Pursuant to 35 U.S.C. § 119 (a), this application claims the benefit of earlier filing date and right of priority to German Patent Application No. 102023206498.7, filed on Jul. 7, 2023, the contents of which are hereby incorporated by reference herein in its entirety.

### BACKGROUND

### 1. Field

Embodiments of the present disclosure relate to a caliper brake, and more particularly, to a caliper brake capable of achieving weight reduction by applying wood or a composite of wood and a metal sheet.

### 2. Description of the Related Art

Due to petroleum energy depletion and the problem of climate change caused by an increase in greenhouse gas emission, automakers around the world focus their efforts on developing technologies for improving fuel efficiency. Among the technologies for improving fuel efficiency, the weight reduction technology for vehicles causing no performance degradation is attracting a lot of attention.

In particular, the weight reduction in a lower portion of a vehicle has a direct effect on the performance and fuel efficiency of the vehicle, and a reduction in the unsprung mass, which is directly related to a wheel driving load, is not only effective in improving fuel efficiency of the vehicle but also can improve the vehicle's conformability.

Here, the unsprung mass is a mass of components provided between a tire and a suspension, meaning the mass of an axle or a wheel, and specifically, may include the mass of a brake disc, a hub, a caliper brake and the like installed on the wheel or the axle.

Meanwhile, the caliper brake largely consists of a housing component, which serves to maintain the overall stiffness of a system during braking, a piston component pushing a friction material by a hydraulic pressure or the like, a carrier component supporting the friction material by the piston, a guide pin guiding the movement of the carrier component, and the like.

Among the components, the housing is integrally fabricated by using mainly a cast iron material, and in order to address the drawback caused by a large proportion of cast iron, the housing is manufactured in one piece using an aluminum material, but there is a problem in that the volume increases and the cost of the material increases in order to maintain stiffness.

Furthermore, as the main components of the caliper brake such as carriers and guide pins are also provided with metallic materials including cast iron or aluminum to secure stiffness, it is difficult to suppress an increase in unsprung mass due to the caliper brake by a method of a structural change for weight reduction.

### SUMMARY

Therefore, it is an aspect of the present disclosure to provide a caliper brake capable of achieving weight reduction by using different materials for each component or each part constituting a single component.

It is another aspect of the present disclosure to provide a caliper brake capable of securing a better attenuation characteristic as compared with a metallic caliper brake.

It is still another aspect of the present disclosure to provide a caliper brake suitable for weight reduction of a battery electric vehicle (BEV) and a small vehicle where relatively strong friction between a disc and a pad has a small braking contribution.

Additional aspects of the disclosure will be set forth in part in the description which follows and, in part, will be obvious from the description, or may be learned by practice of the disclosure.

In accordance with one embodiment of the present disclosure, a caliper brake includes: a disc rotating together with a wheel of a vehicle; a housing including a finger formed to be bent on one side, a cylinder formed to oppose the finger on the other side, and a bridge provided between the finger and the cylinder, and provided to cover at least a part of the disc; a piston provided in the cylinder to move forward and backward to and from the finger; and a pad assembly provided on each of the finger and the cylinder to press or release both sides of the disc by moving forward and backward by the piston, wherein at least one of the housing, the piston, or the pad assembly is provided with a first material including wood or by combining the first material and a second material that is metal.

The first material may be provided by laminating at least one metal layer and at least one wood layer.

The first material may further include a coating layer provided in each of an uppermost layer and a lowest layer.

In the housing, the cylinder may be provided with the first material, and the finger and the bridge may be provided with the second material.

In the housing, the finger may be provided with the first material, and the cylinder and the bridge may be provided with the second material.

In the housing, the bridge may be provided with the first material, and the cylinder and the finger may be provided with the second material.

The piston may be provided with the first material.

The pad assembly may include a friction pad configured to press the disc and a backplate provided with the first material and supporting the friction pad.

The caliper brake may further include a carrier installed to enable the pad assembly to move forward and backward, and the carrier may be provided with the first material.

The housing may further include a fastening bolt for installation with the vehicle, and the fastening bolt may be provided with the first material.

In accordance with another embodiment of the present disclosure, a caliper brake includes: a disc rotating together with a wheel of a vehicle; a housing including a bridge and cylinders respectively provided on both sides of the bridge and provided to cover at least a part of the disc; a piston provided in each of the cylinders to move forward and backward to and from the disc; and a pad assembly provided in each of the cylinders to press or release both sides of the disc by moving forward and backward by the piston, wherein at least one of the housing, the piston, or the pad assembly is provided with a first material including wood or by combining the first material and a second material that is metal.

The first material may be provided by laminating at least one metal layer and at least one wood layer.

The first material may further include a coating layer provided in each of an uppermost layer and a lowest layer.

In the housing, the cylinders may be provided with the first material, and the bridge may be provided with the second material.

In the housing, the bridge may be provided with the first material, and the cylinders may be provided with the second material.

In the housing, any one of the cylinders may be provided with the first material, and the remaining one of the cylinders may be provided with the second material.

The piston may be provided with the first material.

The pad assembly may include a friction pad configured to press the disc and a backplate provided with the first material and supporting the friction pad.

The caliper brake may further include a carrier installed to enable the pad assembly to move forward and backward, and the carrier may be provided with the first material. The housing may further include a fastening bolt for installation with the vehicle, and the fastening bolt may be provided with the first material.

### BRIEF DESCRIPTION OF THE DRAWINGS

These and/or other aspects of the disclosure will become apparent and more readily appreciated from the following description of the embodiments, taken in conjunction with the accompanying drawings of which:

FIGS. 1A and 1B are views each illustrating a cross section of a first material of a caliper brake in accordance with one embodiment of the present disclosure;

FIG. 2 is a view illustrating a cross section of a caliper brake provided as a floating type in accordance with one embodiment of the present disclosure;

FIG. 3 is a view illustrating a cross section of a caliper brake provided as a floating type in accordance with one embodiment of the present disclosure;

FIG. 4 is a view illustrating a cross section of a caliper brake provided as a fixed type in accordance with one embodiment of the present disclosure; and

FIG. 5 is a view illustrating a cross section of a caliper brake provided as a fixed type in accordance with one embodiment of the present disclosure.

### DETAILED DESCRIPTION

Hereinafter, embodiments of the present disclosure will be described in detail with reference to the accompanying drawings. The following embodiment is provided to fully convey the spirit of the present disclosure to a person having ordinary skill in the art to which the present disclosure belongs. The present disclosure is not limited to the embodiment shown herein but may be embodied in other forms. The drawings may omit the illustration of parts not related to the description in order to clarify the present invention, and slightly exaggerate the size of the components to help understanding.

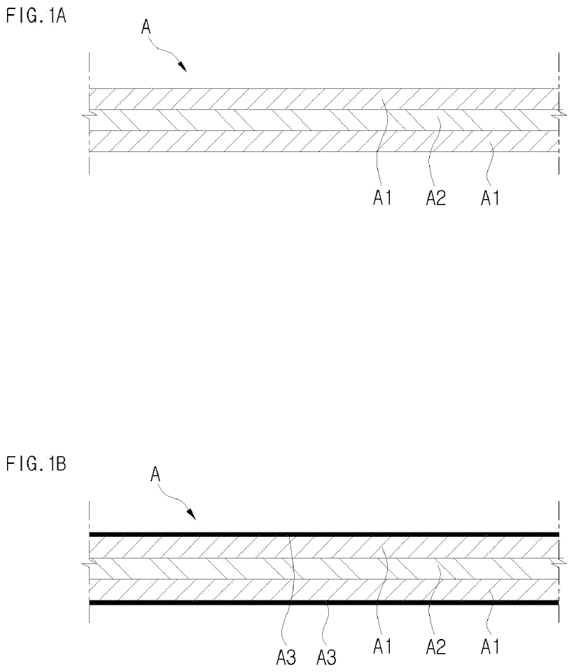

FIGS. 1A and 1B are views each illustrating a cross section of a first material of a caliper brake in accordance with one embodiment of the present disclosure.

Referring to FIG. 1, a first material A is a material including wood and may be formed by laminating and combining a plurality of wood layers A1, which are wood plates or wood sheets, by an adhesive. In addition, in order to improve stability, durability and the like against torsion or bending loads, the first material A may further include a metal layer A2 of a metallic plate or metallic sheet, which is provided between the wood layers A1. Herein, the metal layer A2 may be provided in a multiple number.

In addition, the first material A may further include a coating layer A3 provided in each of an uppermost layer and a lowest layer that are exposed to the outside. Herein, the coating layer A3 may be provided using an incombustible material or various paints to prevent ignition caused by heat, torsion caused by moisture, and the like. In addition, the coating layer A3 may be provided by a thin metallic plate and the like.

The first material A may be used as a single material constituting one component or may be fabricated as one component by being combined with a second material B to be described below through a strong adhesive, a mechanical fastening structure, and the like.

The second material B may be a metallic material such as cast iron or an aluminum alloy and used as a single material constituting one component or may be fabricated as one component by being combined with the first material A through a strong adhesive, a mechanical fastening structure, and the like.

Meanwhile, since the first material A forms a lower proportion than the second material B, the first material A may achieve weight reduction of the caliper brake, when used as a component material of the caliper brake. Also, the first material A has can higher modulus of elasticity more than the second material B. In addition, since the first material A has a better attenuation characteristic than the second material B, the first material A is advantageous for noise, vibration, and harshness (NVH), when used as a component material of the caliper brake.

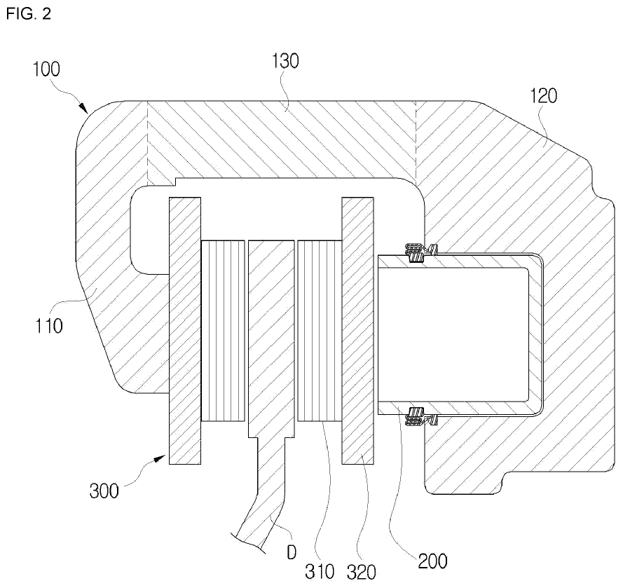

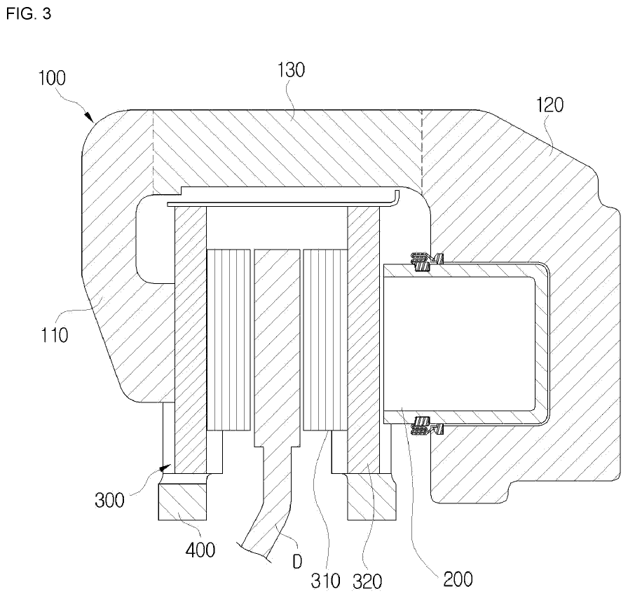

FIGS. 2 and 3 are views each illustrating a cross section of a caliper brake provided as a floating type in accordance with one embodiment of the present disclosure.

Referring to FIGS. 1 to 3, the caliper brake according to one embodiment of the present disclosure includes a housing 100, a piston 200, and a pad assembly 300.

The housing 100 includes a finger 110 formed to be bent on one side, a cylinder 120 formed to oppose the finger 110 on the other side, and a bridge 130 provided between the finger 110 and the cylinder 120 and is provided to cover at least a part of a disc D rotating together with a wheel of a vehicle. Herein, at least one of the finger 110, the cylinder 120, or the bridge 130 may be provided with the first material A, and the remaining parts may be provided with the second material B.

More specifically, in the housing 100, the cylinder 120 may be provided with the first material A, and the finger 110 and the bridge 130 may be provided with the second material B. In addition, in the housing 100, the finger 110 may be provided with the first material A, and the cylinder 120 and the bridge 130 may be provided with the second material B. In addition, in the housing 100, the bridge 130 may be provided with the first material A, and the finger 110 and the cylinder 120 may be provided with the second material B. In addition, in the housing 100, the finger 110 and the cylinder 120 may be provided with the first material A, and the bridge 130 may be provided with the second material B. In addition, in the housing 100, the finger 110 and the bridge 130 may be provided with the first material A, and the cylinder 120 may be provided with the second material B. In addition, in the housing 100, the cylinder 120 and the bridge 130 may be provided with the first material A, and the finger 110 may be provided with the second material B. In addition, in the housing 100, the finger 110, the cylinder 120, and the bridge 130 may all be provided with the first material A or provided with the second material B. In addition, in the housing 100, when any one of the finger 110, the cylinder 120, and the bridge 130 is provided with the second material B, the metal layers A2 of the remaining parts, which are provided with the first material A, may be formed to extend from the part provided with the second material B.

The piston 200 is provided with one side embedded in the cylinder 120 to be able to move forward and backward to and from the finger 110 by a hydraulic pressure or a rotational force of an electric motor or the like. Herein, the piston 200 may be provided with the first material A or provided with the second material B. In addition, when the piston 200 is provided as a single unit obtained by combining a plurality of components, the piston 200 may include a component made of at least the first material A.

The pad assembly 300 is provided on each of the finger 110 side and the cylinder 120 side and provided to press or release the disc D on both sides when being moved forward and backward by the piston 200. More specifically, the pad assembly 300 includes a friction pad 310, which presses the disc D in direct contact therewith, and a backplate 320 supporting the friction pad 310. Herein, as already known, the friction pad 310 may be fabricated using a material including various fibers, resins, metals, and the like. In addition, the backplate 320 may be provided with the first material A to prevent s brake fluid from overheating and prevent a seal provided in each of the friction pad 310 and the backplate 320 from being deformed. In addition, the backplate 320 may also be provided with the second material B.

The caliper brake according to one embodiment of the present disclosure, which is constructed as described above, may further include a carrier 400 on which the pad assembly 300 is installed to move forward and backward. Herein, the carrier 400 may be provided with the first material A and fixed to a car body. In addition, the caliper brake according to one embodiment of the present disclosure, which is constructed as described above, may further include various fastening bolts (not illustrated) for fixing the housing 100 to the car body, fixing the carrier 400 to the car body, and fixing a component to another component. Herein, the fastening bolts may be provided with the first material A. In addition, the carrier 400 and the fastening bolts may be provided with the second material B.

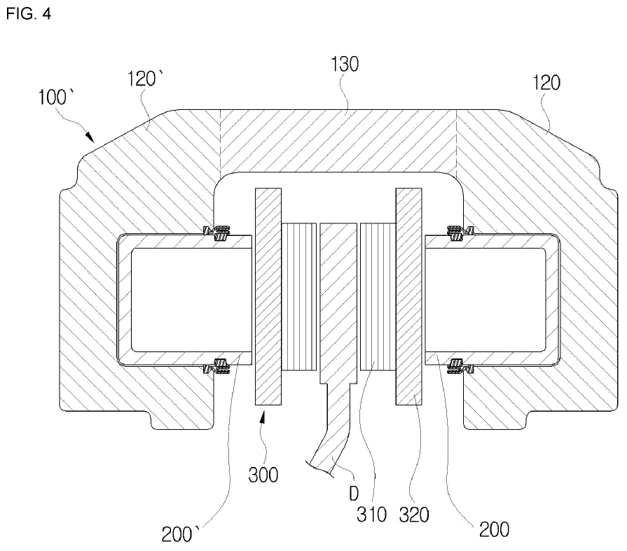

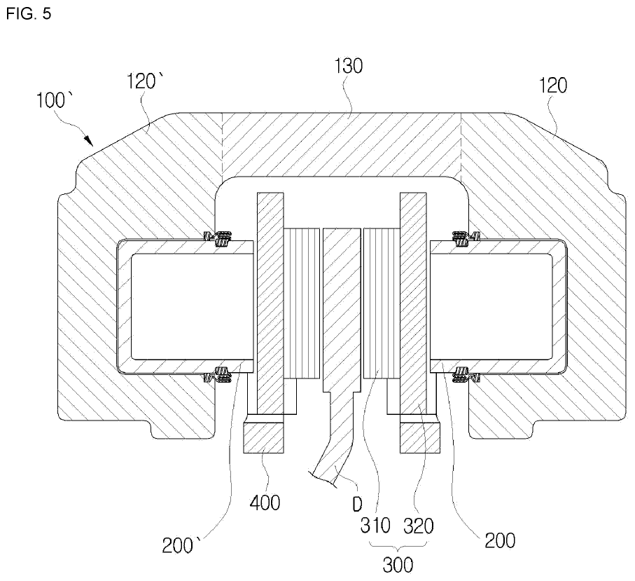

Meanwhile, FIGS. 4 and 5 are views each illustrating a cross section of a caliper brake provided as a fixed type in accordance with one embodiment of the present disclosure.

Referring to FIGS. 1, 4, and 5, the caliper brake according to one embodiment of the present disclosure includes a housing 100′, a piston 200, and a pad assembly 300.

The housing 100′ includes a bridge 130 and cylinders 120 and 120′ respectively provided on both sides of the bridge 130 and is provided to cover at least a part of a disc D rotating together with a wheel of a vehicle. Herein, in the housing 100′, at least one of the cylinders 120 and 120′ or the bridge 130 may be provided with the first material A, and the remaining part may be provided with the second material B.

More specifically, in the housing 100′, the two cylinders 120 and 120′ may be provided with the first material A, and the bridge 130 may be provided with the second material B. In addition, in the housing 100′, any one of the two cylinders 120 and 120′ may be provided with the first material A, and the remaining one and the bridge 130 may be provided with the second material B. In addition, in the housing 100′, the bridge 130 may be provided with the first material A, and the two cylinders 120 and 120′ may be provided with the second material B. In addition, in the housing 100′, any one of the bridge 130 and the two cylinders 120 and 120′ may be provided with the first material A, and the remaining parts may be provided with the second material B. In addition, in the housing 100′, the cylinders 120 and 120′ and the bridge 130 may all be provided with the first material A or provided with the second material B. In addition, in the housing 100′, when any one of the cylinders 120 and 120′ and the bridge 130 is provided with the second material B, the metal layer A2 of the remaining part, which is provided with the first material A, may be formed to extend from the part provided with the second material B.

Pistons 200 and 200′ are provided with one sides embedded in the cylinders 120 and 120′ to be able to move forward and backward to and from the disc D by a hydraulic pressure or a rotational force of an electric motor or the like. Herein, the pistons 200 and 200′ may be provided with the first material A or provided with the second material B. In addition, when the piston 200 is provided as a single unit obtained by combining a plurality of components, the piston 200 may include a component which is provided with at least the first material A.

The pad assembly 300 is provided on each of the cylinders 120 and 120′ and provided to press or release the disc D on both sides when being moved forward and backward by the pistons 200 and 200′. More specifically, the pad assembly 300 includes a friction pad 310, which presses the disc D in direct contact therewith, and a backplate 320 supporting the friction pad 310. Herein, as already known, the friction pad 310 may be fabricated using a material including various fibers, resins, metals, and the like. In addition, the backplate 320 may be provided with the first material A to prevent a brake fluid from overheating and prevent a seal provided in each of the friction pad 310 and the backplate 320 from being deformed. In addition, the backplate 320 may also be provided with the second material B.

The caliper brake according to one embodiment of the present disclosure, which is constructed as described above, may further include a carrier 400 on which the pad assembly 300 is installed to move forward and backward. Herein, the carrier 400 may be provided with the first material A and fixed to a car body. In addition, the caliper brake according to one embodiment of the present disclosure, which is constructed as described above, may further include various fastening bolts (not illustrated) for fixing the housing 100 to the car body, fixing the carrier 400 to the car body, and fixing a component to another component. Herein, the fastening bolts may be provided with the first material A. In addition, the carrier 400 and the fastening bolts may be provided with the second material B.

Accordingly, the caliper brake according to the present embodiment may achieve weight reduction as compared with the conventional metallic caliper brake and thus improve the fuel efficiency and conformability of a vehicle. In addition, the caliper brake according to the present embodiment may secure a better attenuation characteristic as compared with the conventional metallic caliper brake and thus prevent vibrations from lowering the fastening force between components and causing deformation.

In addition, the caliper brake according to the present embodiment, which is constructed as described above, may be more suitable for weight reduction of a battery electric vehicle (BEV) and a small vehicle where a strong frictional force between the disc D and the friction pad 310 has a small braking contribution. In addition, when applied to a normal vehicle, the caliper brake according to the present embodiment may be applied more suitably to a rear axle where a strong frictional force between the disc D and the friction pad 310 has a small braking contribution, as compared with a front axle.

Although the specific embodiment of the caliper brake of the present disclosure has been described, it is clear that various modifications will be made without departing the scope of the present disclosure.

A caliper brake according to the present embodiment can achieve weight reduction by using different materials for each component or each part constituting a single component, thereby improving the fuel efficiency and conformability of a vehicle.

A caliper brake according to the present embodiment can secure a better attenuation characteristic as compared with a metallic caliper brake, thereby preventing vibrations from lowering a fastening force between components and causing deformation.

A caliper brake according to the present embodiment can be more suitable for weight reduction of a battery electric vehicle (BEV) and a small vehicle where a strong frictional force between a disc and a pad has a small braking contribution.

Therefore, the scope of the present disclosure is not limited to the described embodiments and should be defined by equivalents of the appended claims as well as the scope of the appended claims.

That is, it should be understood that the above-described embodiments are illustrative in all aspects and not restrictive, the scope of the present disclosure is indicated by the appended claims described below rather than the detailed description, and it should be construed that the meaning and scope of the appended claims and all changes or modifications derived from equivalent concepts thereof are included in the scope of the present disclosure.

What is claimed is:

1. A caliper brake comprising:
a disc rotating together with a wheel of a vehicle;
a housing including a finger formed to be bent on one side, a cylinder formed to oppose the finger on the other side, and a bridge provided between the finger and the cylinder, and provided to cover at least a part of the disc;
a piston provided in the cylinder to move forward and backward to and from the finger; and
a pad assembly provided on each of the finger and the cylinder to press or release both sides of the disc by moving forward and backward by the piston,
wherein at least one of the housing, the piston, or the pad assembly is provided with a first material including wood or by combining the first material and a second material that is metal.

2. The caliper brake of claim 1, wherein the first material is provided by laminating at least one metal layer and at least one wood layer.

3. The caliper brake of claim 2, wherein the first material further comprises a coating layer provided in each of an uppermost layer and a lowest layer.

4. The caliper brake of claim 1, wherein in the housing, the cylinder is provided with the first material, and
the finger and the bridge are provided with the second material.

5. The caliper brake of claim 1, wherein in the housing, the finger is provided with the first material, and
the cylinder and the bridge are provided with the second material.

6. The caliper brake of claim 1, wherein in the housing, the bridge is provided with the first material, and
the cylinder and the finger are provided with the second material.

7. The caliper brake of claim 1, wherein the piston is provided with the first material.

8. The caliper brake of claim 1, wherein the pad assembly comprises:
a friction pad configured to press the disc; and
a backplate provided with the first material and supporting the friction pad.

9. The caliper brake of claim 1, further comprising a carrier installed to enable the pad assembly to move forward and backward,
wherein the carrier is provided with the first material.

10. The caliper brake of claim 1, wherein the housing further comprises a fastening bolt for installation with the vehicle, and
the fastening bolt is provided with the first material.

11. A caliper brake comprising:
a disc rotating together with a wheel of a vehicle;
a housing including a bridge and cylinders respectively provided on both sides of the bridge and provided to cover at least a part of the disc;
a piston provided in each of the cylinders to move forward and backward to and from the disc; and
a pad assembly provided in each of the cylinders to press or release both sides of the disc by moving forward and backward by the piston,
wherein at least one of the housing, the piston, or the pad assembly is provided with a first material including wood or by combining the first material and a second material that is metal.

12. The caliper brake of claim 11, wherein the first material is provided by laminating at least one metal layer and at least one wood layer.

13. The caliper brake of claim 12, wherein the first material further comprises a coating layer provided in each of an uppermost layer and a lowest layer.

14. The caliper brake of claim 11, wherein in the housing, the cylinders are provided with the first material, and
the bridge is provided with the second material.

15. The caliper brake of claim 11, wherein in the housing, the bridge is provided with the first material, and
the cylinders are provided with the second material.

16. The caliper brake of claim 11, wherein in the housing, any one of the cylinders is provided with the first material, and
the remaining one of the cylinders is provided with the second material.

17. The caliper brake of claim 11, wherein the piston is provided with the first material.

18. The caliper brake of claim 11, wherein the pad assembly comprises:
a friction pad configured to press the disc; and
a backplate provided with the first material and supporting the friction pad.

19. The caliper brake of claim 11, further comprising a carrier installed to enable the pad assembly to move forward and backward,
wherein the carrier is provided with the first material.

20. The caliper brake of claim 11, wherein the housing further comprises a fastening bolt for installation with the vehicle, and
the fastening bolt is provided with the first material.
